(19) United States
(12) Patent Application Publication
(10) Pub. No.: US 2015/0254737 A1
(43) Pub. Date: Sep. 10, 2015

(54) METHOD, APPARATUS AND SYSTEM FOR PROVIDING CUSTOMIZED SERVICE BASED ON BEACON SIGNAL

(71) Applicant: SK PLANET CO., LTD., GYEONGGI-DO (KR)

(72) Inventors: CHUL YONG SHIN, SEOUL (KR); JAE HYUNG HUH, GYEONGGI-DO (KR)

(73) Assignee: SK PLANET CO., LTD., GYEONGGI-DO (KR)

(21) Appl. No.: 14/638,479

(22) Filed: Mar. 4, 2015

(30) Foreign Application Priority Data
Mar. 10, 2014 (KR) 10-2014-0027780

(51) Int. Cl. G06Q 30/02; H04W 4/00; H04B 17/318; H04W 4/02

(52) U.S. Cl. CPC G06Q 30/0281; H04W 4/023; H04W 4/008; H04B 17/318; G06Q 30/0252

(57) ABSTRACT

A method, apparatus and system for providing a customized service based on a beacon signal are disclosed. The terminal device identifies at least one beacon device through the scanning of a beacon signal transmitted from the beacon device, calculates a distance to the identified beacon device using the beacon signal of the identified beacon device, and transmits information about the calculated distance and beacon identification information to a service device. The service device generates customized information based on the distance to the beacon device using the distance information and the beacon identification information received from the terminal device, and provides the generated customized information to the terminal device.

### CROSS-REFERENCE TO RELATED APPLICATION

This application claims the benefit of Korean Patent Application No. 10-2014-0027780, filed Mar. 10, 2014, which is hereby incorporated by reference herein in its entirety.

### BACKGROUND

1. Technical Field

The present disclosure relates generally to a customized service and, more particularly, to a method, apparatus and system for providing a customized service based on a beacon signal, which are capable of calculating a distance to a beacon device using a beacon signal received from the beacon device, located in a store, via short-range wireless communication, and then providing customized information to a user based on the calculated distance.

2. Description of the Related Art

This section is not intended to be an admission of prior art, but is intended to simply provide background information related to embodiments.

With the development of mobile communication networks and the advancement of terminal specifications, mobile communication terminals have become the necessities of people today and are evolving into total entertainment devices, beyond the scope of conventional simple communication devices or information provision devices.

Furthermore, technologies for enabling mobile communication terminals to perform short-range wireless communication over a short distance have rapidly developed. One of these short-range wireless communication technologies is a Bluetooth communication technology.

The Bluetooth communication technology has evolved continuously. Recently, Bluetooth Low Energy (BLE) is being widely used in the fields of smart phones, geofencing, mobile payment, etc. BLE consumes lower power than the standard Bluetooth wireless connection technology, and is most recently being chiefly used in the field of mobile payment.

However, mobile payment using short-range wireless communication is in its early stages. In recent mobile payment technology, when a terminal recognizes a beacon signal, the terminal can provide information related to the beacon signal, and simply provides general information. Accordingly, a problem arises in that a user indiscriminately receives unnecessary information.

Furthermore, so far, store-related information has been provided to a user via junk mail or a push message, and customized information cannot be provided to a user via a beacon signal.

### SUMMARY

Accordingly, at least one embodiment of the present invention is intended to provide a method, apparatus and system for providing a customized service based on a beacon signal, in which a terminal device scans a beacon signal transmitted from at least one beacon device via short-range wireless communication, calculates a distance to the corresponding beacon device using the scanned beacon signal, determines whether a user has entered a store using information about the calculated distance, receives inducement information or detailed information about the store from a service device depending on whether the user has entered the store, and then outputs the received information to the user.

At least one embodiment of the present invention is intended to provide a method, apparatus and system for providing a customized service based on a beacon signal, in which a service device identifies corresponding stores, where beacon devices are located, using beacon signals scanned by a terminal device, calculates a distance from the terminal device to a beacon device located in a user-preferred store selected from among the identified stores, determines whether the user has entered the store using information about the calculated distance, and then transmits inducement information or detailed information about the store to the terminal device depending on whether the user has entered the store.

In accordance with an aspect of the present invention, there is provided a terminal device, including a communication unit configured to receive a beacon signal transmitted from at least one beacon device via short-range wireless communication, and to communicate with a service device over a communication network to provide a customized service based on the beacon signal; a control unit functionally connected with the communication unit, and configured to scan the beacon signal transmitted from the beacon device, to determine whether a user has entered a store, in which the beacon device is located, through the calculation of a distance to the beacon device using the scanned beacon signal, to transmit information, indicative of whether the user has entered the store, to the service device, and to receive information related to the store, adapted to differ depending on whether the user has entered the store, from the service device; and an output unit functionally connected with the control unit, and configured to output the information related to the store, received from the service device, depending on whether the user has entered the store in order to provide the customized service to the user.

The terminal device may further include a storage unit configured to store the information related to the store and an application; wherein the information related to the store is provided by the service device depending on whether the user has entered the store under the control of the control unit, and the application is used to execute the customized service based on the beacon signal.

In the service terminal, the control unit may be further configured to calculate the distance to the beacon device using the Received Signal Strength Indicator (RSSI) and transmission power values of the scanned beacon signal.

In the service terminal, the control unit may be further configured to, if information about the calculated distance is equal to or larger than a predetermined reference value, determine that the user is located outside the store and then receive inducement information, adapted to induce the user to enter the store, from the service device as the information related to the store.

In the service terminal, the inducement information may include one or more of the location information, discount information, event information and advertising information of the store.

In the service terminal, the control unit may be further configured to, if information about the calculated distance is smaller than a predetermined reference value, determine that the user has entered the store and then receive detailed information about the store from the service device as the information related to the store.

In the service terminal, the detailed information about the store may be information to be received if the user has entered the store, and includes one or more of product-on-sale information, product price information, discount product information, best-selling product information, product-of-interest information, a coupon, a gift certificate, detailed event information and alliance service information.

In accordance with another aspect of the present invention, there is provided a service device, including a communication unit configured to operate in conjunction with at least one terminal device over communication network, and to perform communication for a customized service; and a service provision unit functionally connected with the communication unit, and configured to, when a request for information is received from the terminal device, determine whether a user has entered a store, in which a beacon device is located, using information about a distance to the beacon device and the identification information of the beacon device received from the terminal device, to generate different information related to the store to be provided to the user depending on whether the user has entered the store, and to provide the generated information related to the store to the terminal device.

In the service device, the service provision unit may be further configured to identify the store, in which the beacon device is located, using the identification information of the beacon device, to collect information related to the identified store, and to generate inducement information adapted to induce the user to enter the identified store from the collected information based on user information if the user is located outside the identified store.

In the service device, the service provision unit may be further configured to identify the store, in which the beacon device is located, using the identification information of the beacon device, to collect information related to the identified store, and to generate detailed information about the identified store from the collected information if the user has entered the identified store based on user information.

In accordance with still another aspect of the present invention, there is provided a service device, including a communication unit configured to operate in conjunction with at least one terminal device over communication network, and to perform communication for a customized service; and a service provision unit functionally connected with the communication unit, and configured to receive beacon signals scanned by the terminal device, to identify corresponding stores where beacon devices corresponding to identification information included in the received beacon signals are located, to determine a distance from the terminal device to a beacon device located in a selected store using the beacon signal of the beacon device located in the store selected from among the identified stores based on preset user information, to determine whether a user has entered the store according to the determined distance, to generate different information related to the store for the customized service depending on whether the user has entered the store, and to provide the generated information related to the store to the terminal device.

In the service device, the service provision unit may be further configured to calculate a distance from the terminal device to the beacon device located in the selected store using the RSSI and transmission power values of the beacon signal of the beacon device located in the selected store, to collect information related to the selected store based on information about the calculate distance, and to generate the collected information as information related to the store.

In the service device, the service provision unit may be further configured to determine a predetermined level corresponding to the RSSI and transmission power values of the beacon signal of the beacon device located in the selected store, to determine a distance from the terminal device to the beacon device, located in the selected store, corresponding to the determined level, to collect information related to the selected store based on information about the determined distance, and to generate the collected information as information related to the store.

In accordance with still another aspect of the present invention, there is provided a system for providing a customized service based on a beacon signal, including a terminal device configured to scan a beacon signal transmitted from at least one beacon device via short-range wireless communication and then identify a beacon device, to determine whether a user has entered a store, in which the beacon device is located, through the calculation of a distance to the identified beacon device, to transmit information, indicative of whether the user has entered the store, to the service device, and to receive information related to the store, adapted to differ depending on whether the user has entered the store, from the service device; and a service device configured to, when a request for information is received from the terminal device, generate different information related to the store to be provided to the user depending on whether the user has entered the store, and to provide the generated information related to the store to the terminal device.

In accordance with still another aspect of the present invention, there is provided a method for providing a customized service based on a beacon signal, including scanning a beacon signal transmitted from at least one beacon device via short-range wireless communication; identifying the beacon device using the scanned beacon signal; calculating a distance to the identified beacon device using the beacon signal of the identified beacon device; determining whether a user has entered a store, in which the beacon device is located, using information about the calculated distance; transmitting information indicative of whether the user has entered the store to a service device; receiving information related to the store, adapted to differ depending on whether the user has entered the store, from the service device; and storing and outputting the information related to the store.

In accordance with still another aspect of the present invention, there is provided a method for providing a customized service based on a beacon signal, including receiving an information request message, including information about a distance to a beacon device, calculated by a terminal device, and identification information of the beacon device from the terminal device; identifying a store, in which the beacon device is located, using the identification information of the beacon device; determining whether a user has entered the identified store using the distance information; generating different information related to the store for a customized service depending on whether the user has entered the store; and providing the generated information related to the store to the terminal device depending on whether the user has entered the store.

In the method for providing a customized service based on a beacon signal, generating the different information related to the store for the customized service depending on whether the user has entered the store may include collecting information related to the identified store; sorting out inducement information, adapted to induce the user to enter the store, from the collected information if the user is located outside the identified store; and generating the sorted-out inducement information as the information related to the store to be provided to the terminal device.

In the method for providing a customized service based on a beacon signal, generating the different information related to the store for the customized service depending on whether the user has entered the store may include collecting information related to the identified store; sorting out detailed information about the store from the collected information if the user is located inside the identified store; and generating the sorted-out detailed information about the store as the information related to the store to be provided to the terminal device.

In accordance with still another aspect of the present invention, there is provided a method for providing a customized service based on a beacon signal, including receiving beacon signals scanned from one or more terminal devices; identifying corresponding stores in which beacon devices corresponding to identification information included in the received beacon signals are located; selecting a user-preferred store from among the identified stores based on predetermined user information; calculating a distance from the terminal device and the selected store using the beacon signal of the beacon device that is located in the selected store; determining whether a user has entered the selected store using information about the calculated distance; generating different information related to the store for a customized service depending on whether the user has entered the store; and providing the generated information related to the store to the terminal device depending on whether the user has entered the store.

In accordance with still another aspect of the present invention, there is provided a computer-readable storage medium having stored therein computer-readable program instructions that, when executed by a computer, cause the computer to perform a method for providing a customized service based on a beacon signal.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the configuration of a system for providing a customized service based on a beacon signal according to embodiments of the present;

FIG. 2 is a diagram illustrating the configuration of a terminal device in the system for providing a customized service based on a beacon signal according to the embodiments of the present invention;

FIG. 3 is a diagram illustrating the configuration of a service device in the system for providing a customized service based on a beacon signal according to the embodiments of the present invention;

FIG. 4 is a flowchart illustrating a method of providing a customized service based on a beacon signal in a terminal device according to a first embodiment of the present invention;

FIG. 5 is a flowchart illustrating a method of providing a customized service based on a beacon signal in a service device according to the first embodiment of the present invention;

FIG. 6 is a flowchart illustrating a method of providing a customized service based on a beacon signal in a terminal device according to a second embodiment of the present invention;

FIG. 7 is a flowchart illustrating a method of providing a customized service based on a beacon signal in a service device according to the second embodiment of the present invention; and

FIG. 8 is a diagram of an example illustrating the location of a user based on the calculation of a distance to a beacon device according to the embodiments of the present invention.

### DETAILED DESCRIPTION

Embodiments of the present invention will be described in detail below with reference to the accompanying drawings. Detailed descriptions of well-known functions and configurations that would make the gist of the present invention obscure will be omitted. Furthermore, it should be noted that the same elements will be designated by the same reference numerals throughout the accompanying drawings as much as possible.

Terms and words that are described below and used in the present specification and the claims should not be interpreted as having common and dictionary meanings, but should be interpreted as having meanings and concepts in accordance with the technical spirit of the present invention based on the principle in which an inventor can appropriately define the concepts of terms to describe his or her invention in the most appropriate way. Accordingly, since configurations illustrated in embodiments described herein and the accompanying drawings correspond merely to embodiments of the present invention and do not represent the overall technical spirit of the present invention, it should be understood that various equivalents and modifications that may replace the configurations at the time when the present application is filed.

A system for providing a customized service based on a beacon signal according to an embodiment of the present is described in detail with reference to the accompanying drawings.

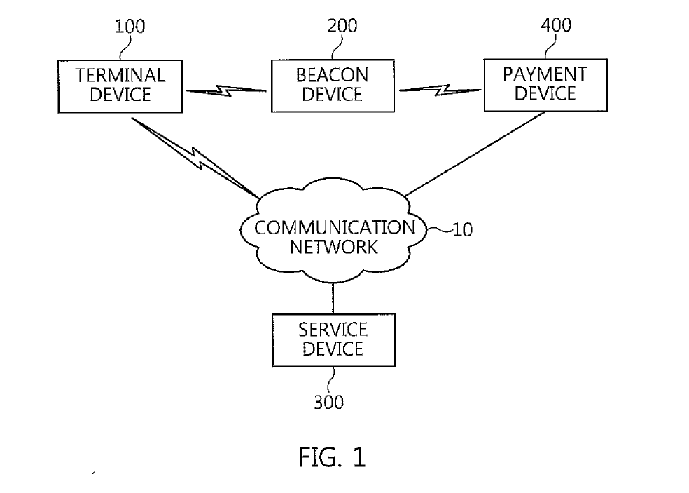

FIG. 1 is a diagram illustrating the configuration of the system for providing a customized service based on a beacon signal according to this embodiment of the present.

Referring to FIG. 1, the system for providing a customized service based on a beacon signal includes at least one terminal device 100, at least one beacon device 200, a service device 300 and a payment device 400 that are connected over a communication network 10.

The terminal device 100 is a terminal that can transmit or receive various types of data over the communication network 10 through the key manipulation of a user. The terminal device 100 may be any one of a tablet Personal Computer (PC), a laptop, a PC, a smart phone, a Portable Digital Assistant (PDA), a smart TV, a mobile communication terminal, etc.

Furthermore, the terminal device 100 is a terminal that performs the communication of sound or data over the communication network 10. The terminal device 100 refers to a terminal, including a browser configured to communicate with the service device 300 over the communication network 10, memory configured to store a program and a protocol, a microprocessor configured to execute various types of programs and then perform operations and control. That is, the terminal device 100 may be any type of terminal as long as the terminal can perform server-client communication with the service device 300 and also execute a customized service. The terminal device 100 is based on a broad concept that encompasses communication computing devices, such as a notebook computer, a mobile communication terminal and a PDA. Meanwhile, the terminal device 100 may be fabricated in a form having a touch screen, but is not limited thereto.

Furthermore, the terminal device 100 is a terminal device via which a short-range wireless communication (for example, a Bluetooth Low Energy (BLE) communication, a Wi-Fi communication, or the like) can be performed. The terminal device 100 may connect with the beacon device 200 via the short-range wireless communication and then transmit or receive mobile payment information or mobile payment-related information to or from the payment device 400. In this embodiment of the present invention, BLE communication is described below as an example. In this case, it should be noted that this embodiment of the present invention is not limited to a BLE communication method, but may use any type of communication method as long as the method can perform short-range wireless communication.

In particular, the terminal device 100 according to this embodiment of the present invention may scan a beacon signal generated by the beacon device 200, and then may identify the beacon device 200 to be connected using the scanned beacon signal. For this purpose, the terminal device 100 may receive an application, used to identify the beacon devices 200, from the service device 300, may install the application, may execute the application, and then may scan a BLE beacon signal. Furthermore, the terminal device 100 may calculate a distance to the beacon device 200 using the beacon signal received from the identified beacon device 200, may receive a customized service based on the beacon signal from the service device 300 using information about the calculated distance, and then may provide the service to a user. That is, it is determined based on the distance information whether the user has entered a store. If the user has not entered the store, information adapted to induce the user to enter a store may be received as store-related information for a customized service and be then output. In contrast, if the user has entered the store, detailed store information may be received as store-related information for a customized service and be then output.

Meanwhile, the terminal device 100 according to a second embodiment of the present invention may scan beacon signals generated by one or more beacon devices 200, and then may transmit the scanned beacon signals to the service device 300. Accordingly, the terminal device 100 may receive customized information, generated based on calculated distances to the beacon devices 200, from the service device 300.

The beacon device 200 according to the embodiments of the present invention may be located in the store, may perform BLE communication with the one or more terminal devices 100 and the payment device 400 of the store, and may broadcast a beacon signal including unique identification information to the one or more terminal devices 100.

The service device 300 according to the embodiments of the present invention may perform communication for the customized service in conjunction with the terminal devices 100 over a communication network 10, and then may provide an application, configured to provide a customized service based on the beacon signal, to the terminal devices 100.

Furthermore, if the service device 300 according to the first embodiment of the present invention has received a request for information from the terminal device 100, the service device 300 may generate customized information based on a distance to the beacon device 200 using distance information and the identification information of the beacon device 200 (hereafter referred to as “beacon identification information”) received from the terminal device 100, and then may provide the generated customized information to the terminal device 100.

Meanwhile, the service device 300 according to the second embodiment of the present invention receives scanned beacon signals from the terminal devices 100, the service device 300 may select a user-preferred store from among stores, identified using the received beacon signals, based on preset user information. Furthermore, the service device 300 may calculate a distance from the terminal device 100 to the selected store using the beacon signal of the beacon device located in the selected store, may generate customized information based on the calculated distance, and then may provide the generated customized information to the terminal device 100.

The terminal device 100 and the service device 300 operate in conjunction with each other over the communication network 10. This communication network 10 refers to a network that can transmit and receive data in accordance with the Internet Protocol using various wired/wireless communication networks, such as the Internet, an intranet, a mobile communication network, and a satellite communication network. Furthermore, the communication network 10 may be coupled with the service device 300, and may store computing resources, such as hardware and software. This communication network 10 is based on a concept that includes: closed networks, such as a Local Area Networks (LAN) and a Wide Area Network (WAN); open networks, such as the Internet; networks, such as a Code Division Multiple Access (CDMA) network, a Wideband Code Division Multiple Access (WCDMA) network, a Global System for Mobile communication (GSM) network, a Long Term Evolution (LTE) network and a Evolved Packet Core (EPC) network; a next generation network that will be implemented in the future; and a computing network.

The configuration of the terminal device in the system for providing a customized service based on a beacon signal according to the embodiments of the present invention is described below with reference to the accompanying drawings.

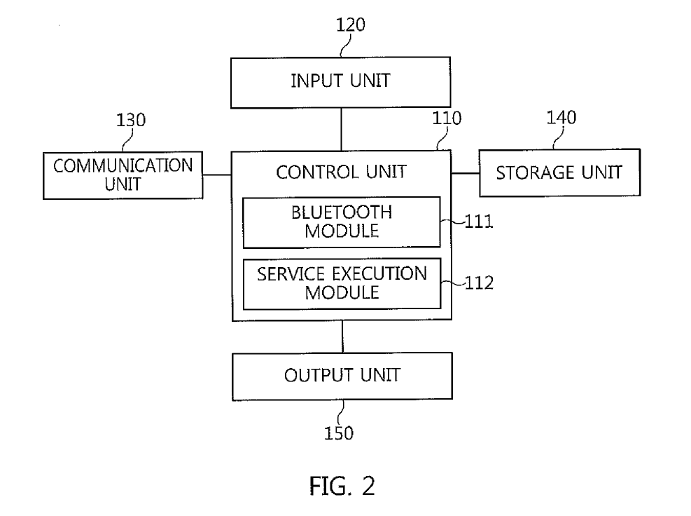

FIG. 2 is a diagram illustrating the configuration of the terminal device in the system for providing a customized service based on a beacon signal according to the embodiments of the present invention is described below with reference to the accompanying drawings.

Referring to FIG. 2, the terminal device 100 may be configured to include a control unit 110, an input unit 120, a communication unit 130, a storage unit 140, and an output unit 150.

The control unit 110 may perform the overall control of the terminal device 100, and, in particular, may perform the control of BLE communication with the beacon devices 200 and perform control for the provision of customized services using beacon signals generated by the beacon devices 200. For this purpose, the control unit 110 may be configured to include a Bluetooth module 111 and a service execution module 112.

The Bluetooth module 111 according to the embodiments of the present invention may perform control for the performance of BLE communication in conjunction with the beacon devices 200, may scan beacon signals broadcast by the beacon devices 200, and then may transfer the scanned beacon signals to the service execution module 112. Furthermore, the Bluetooth module 111 may perform control for the identification of the beacon devices 200 using identification information included in the scanned beacon signals, and then may perform a connection procedure with the beacon devices 200.

The service execution module 112 according to the embodiments of the present invention may receive an application for providing a user with a customized service using a beacon signal from the service device 300, may install the application, and may execute the installed application, thereby executing the customized service based on the beacon signal.

Furthermore, the service execution module 112 according to a first embodiment of the present invention may identify the beacon device 200 using identification information included in a beacon signal received from the Bluetooth module 111, and may calculate a distance to the identified beacon device 200. In this case, the service execution module 112 may calculate a distance to the beacon device 200 using the Received Signal Strength Indicator (RSSI) and transmission power values of a beacon signal generated by the identified beacon device 200. For example, the service execution module 112 may obtain a loss value, that is, the difference between the transmission power value and the RSSI value, and then may calculate the distance to the beacon device 200 using the loss value. In this case, the maximum communication distance of BLE is, for example, within 50 m, and identification speed is about 6 ms. In another example, distance values corresponding to RSSI values may be preset through experiments and stored in a distance table in advance. When a distance is calculated, a distance value corresponding to an RSSI value and stored in the distance table may be read, and then the distance to the beacon device 200 may be calculated.

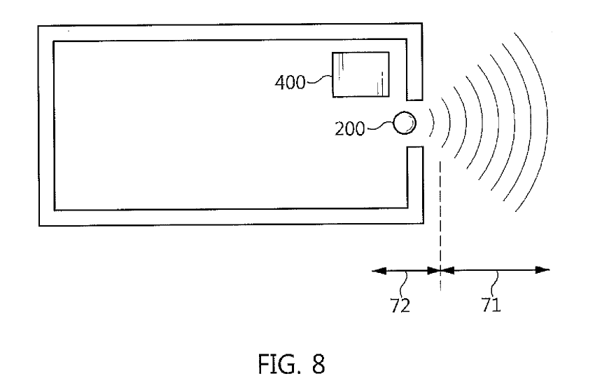

Furthermore, the service execution module 112 may determine whether a user has entered a store, in which the beacon device 200 is located, through the identification of the location of the user using information about the calculated distance. That is, the service execution module 112 may determine the location of the user using information about a calculated distance and a predetermined reference value (for example, 1 m). In this case, the predetermined reference value may be preset by the user, or may be provided by the service device 300 in advance. For this purpose, if the information about the calculated distance is equal to or larger than the predetermined reference value, the service execution module 112 may determine that the user is in an area 71 outside a store where the beacon device 200 is located, as illustrated in FIG. 8. Meanwhile, if the information about the calculated distance is smaller than the predetermined reference value, the service execution module 112 may determine that the user is in an area 72 inside the store where the beacon device 200 is located, as illustrated in FIG. 8.

Furthermore, the service execution module 112 may transmit an information request message, including information about a calculated distance, information indicative of whether a user has entered a store and the identification information of the beacon device 200, to the service device 300. Accordingly, the service execution module 112 may control to receive store-related information (inducement information or detailed store information), generated based on whether a user has entered a store using information about the calculated distance and the identification information of the beacon device 200, from service device 300, and then to store and output the received store-related information (inducement information or detailed store information). In this case, the inducement information is information that is used to induce the user to enter the store. The inducement information may include one or more of store location information, discount information, event information and advertising information.

Furthermore, the detailed store information is information that is provided if a user has entered a store. The detailed store information may include one or more of product-on-sale information, product price information, discount product information, best-selling product information, product-of-interest information, a coupon, a gift certificate, event information, and alliance service information.

More specifically, if it is determined whether a user has not entered a store because information about a calculated distance is smaller than the reference value, the service execution module 112 may receive inducement information, such as event information, for example, “a 20% discount coupon for a time sale product will be provided upon a visit to a store”, or discount information for today's product, from the service device 200 in response to a request for information.

Thereafter, if a user has entered the store after checking the inducement information, the service execution module 112 may determine the current location of the user, that is, whether the user has entered the store, based on information about the calculated distance, and then may receive, for example, a coupon (a 20% discount coupon) attributable to inducement event information from the service device 200 as detailed store information in response to a request for information. Furthermore, the service execution module 112 may receive information about one or more of a user-preferred product based on user information, a product of interest generated using previous payment information, today's product, a best-selling product, a main product sold in a store and a time sale product, and discount information and alliance-service information about these products. Accordingly, if a user checks the received detailed store information and then makes a request for the purchase of a desired product, the service execution module 112 may read information about a provided coupon in response to a request from the user, may transmit the information about the coupon to the device 400, and thus may request a discount on a purchased product. Meanwhile, the service execution module 112 according to the second embodiment of the present invention may transmit a scanned beacon signal, transferred from the Bluetooth module 111, to the service device 300. Accordingly, the service execution module 112 may receive customized information, generated based on a distance to the beacon device 200, from the service device 300.

The input unit 120 may generate a user input signal corresponding to a request from a user or information through the manipulation of the user, and may be implemented as various input means that are commonly used currently or will be commonly used in the future. The input unit 120 may include a gesture input means capable of detecting the motion of a user and then generating a specific input signal, as well as a general input device, such as a keyboard, a mouse, a joy stick, a touch screen or a touch pad. In particular, the input unit 120 according to the embodiments of the present invention may generate a Bluetooth-ON input signal and an application-execution input signal for a customized service.

The communication unit 130 may communicate with the service device 300 over the communication network 10 and transmit and receive messages related to a customized service based on the beacon signal. This communication unit 130 may transmit and receive data using various communication methods as well as wired and wireless methods. Furthermore, the communication unit 130 may transmit and receive data using one or more communication methods. For this purpose, the communication unit 130 may include a plurality of communication modules that transmit and receive data using different communication methods. In particular, the communication unit 130 according to the embodiments of the present invention may transmit and receive related messages required to perform short-range wireless communication (for example, BLE communication) with the beacon device 200, may transmit an information request message, including distance information and a beacon signal (the identification information of the beacon device 200), to the service device 300. Furthermore, the communication unit 130 may receive a message, including customized information (inducement information, detailed store information, etc.), from the service device 300.

The storage unit 140 stores information required for the operation of the terminal device 100. In particular, the storage unit 140 according to the embodiments of the present invention may store scanned beacon signals, information about a calculated distance, and customized information (inducement information, detailed store information, etc.) received from the service device 300. This storage unit 140 includes: magnetic media, such as a hard disk, a floppy disk and a magnetic tape; optical media, such as Compact Disk Read-Only Memory (CD-ROM) and a Digital Video Disk (DVD); magneto-optical media, such as a floptical disk; Read-Only Memory (ROM); Random Access Memory (RAM); and flash memory.

Furthermore, the storage unit 140 according to the embodiments of the present invention stores an application program required for the operation of a function, and a screen image to be output onto the display unit of the output unit 150. Furthermore, the storage unit 140 may store a key map and a menu map for the operation of a touch screen when the display unit is implemented as the touch screen. In this case, each of the key map and the menu map may have various forms. This storage unit 140 may store an Operating System (OS) for booting the terminal device 100 and operating the above-described configurations, and application programs for supporting various user functions, for example, a user function of supporting the call function of the terminal device 100, an MP3 user function of playing back sounds, an image output function of playing back photos and the like, a function of playing back moving images, etc.

The output unit 150 is a means for providing the operation results or state of the terminal device 100 so that the user checks the operation results or state of the terminal device 100. The output unit 150 may include, for example, a display unit for performing visual output via a screen, a speaker for outputting audible sounds, and the like. In particular, the terminal device 100 according to the embodiments of the present invention may display a screen related to a customized service based on a beacon signal, and may display customized information, received from the service device 300, on a service execution screen. Furthermore, a screen for allowing the ON/OFF manipulation of BLE communication to be performed may be output.

Furthermore, the configuration of the service device in the system for providing a customized service based on a beacon signal according to the embodiments of the present invention is described below with reference to the accompanying drawings.

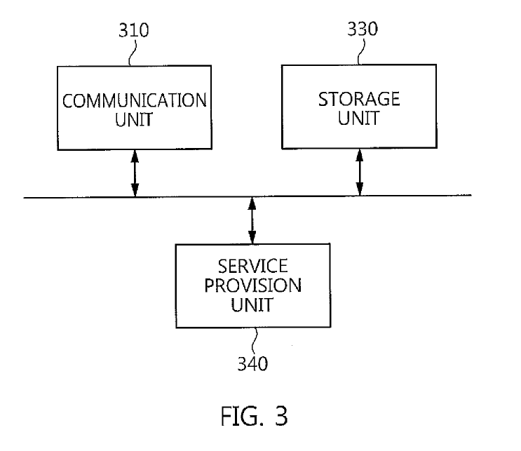

FIG. 3 is a diagram illustrating the configuration of the service device 300 in the system for providing a customized service based on a beacon signal according to the embodiments of the present invention.

Referring to FIG. 3, the service device 300 may be configured to include a communication unit 310, a service provision unit 320, and a storage unit 330.

The communication unit 310 according to the embodiments of the present invention may communicate with the one or more terminal devices 100 over the communication network 10 and transmit and receive messages for a customized service. This communication unit 310 may collect traffic information using various communication methods as well as wired and wireless methods, and may communicate with the mobile terminal device 100 over a mobile communication network using the wireless method. Furthermore, the communication unit 310 may transmit and receive data using one or more communication methods. For this purpose, the communication unit 310 may include a plurality of communication modules that transmit or receive data using different communication methods.

The service provision unit 320 according to the first embodiment of the present invention is functionally connected with the communication unit 310, and, when an information request message is received from the terminal device 100, may determine whether a user has entered a store using information about whether the user has entered the store, distance information and beacon identification information that are included in the information request message.

For this purpose, the service provision unit 320 may identify a store where the beacon device 200 is located using the beacon identification information, may collect information related to the identified store, and may classify the collected information based on distance information. Furthermore, in order to induce a user to enter a store if the user has not entered the store, the service provision unit 320 may collect information, provided by the store, or information about the location of the store, event information and discount information, provided by a cooperative company, from the classified information based on user information, and then may generate the collected information as inducement information. In contrast, if the user has entered the store, the service provision unit 320 may collect product information and alliance service information related to the store, and then may generate the collected information as detailed store information.

If information about whether the user has entered the store has not been received from the terminal device 100, the service provision unit 320 may determine the location of a user, that is, whether the user has entered the store, using received distance information and store identification information. For this purpose, as illustrated in FIG. 8, the service provision unit 320 may determine that the user is located in the area 71 outside the identified store if information about a calculated distance is equal to or larger than a predetermined reference value, or may receive information indicative that the user is located in the area 71 outside the identified store from the terminal device 100 and then perform determination. In this case, the service provision unit 320 may sort out inducement information to be transmitted from information, collected using beacon identification information, based on distance information, that is, if the user is located outside the store, and then may generate the sorted-out inducement information as store-related information for a customized service to be transmitted to the terminal device 100.

In contrast, as illustrated in FIG. 8, the service provision unit 320 may determine that the user is located in the area 72 inside the identified store if the information about the calculated distance is smaller than the predetermined reference value, or may receive information indicative that the user is located in the area 72 inside the identified store from the terminal device 100 and perform determination. In this case, the service provision unit 320 may sort out detailed store information to be transmitted from the information, collected using the beacon identification information, based on the distance information, that is, if the user is located inside the store, and then may generate the sorted-out detailed store information as store-related information for a customized service to be transmitted to the terminal device 100.

Meanwhile, the service provision unit 320 according to the second embodiment of the present invention may receive beacon signals scanned by the terminal device 100, may identify corresponding stores where the beacon devices 200 corresponding to identification information included in the received beacon signals are located, and then may select a user-preferred store from among the identified stores based on preset user information. Furthermore, the service provision unit 320 may calculate a distance from the terminal device 100 to the selected store using the beacon signal (that is, the RSSI and transmission power values of the beacon signal) of the beacon device 200 located in the selected store, may generate inducement information or detailed store information based on the calculated distance, and then may provide the generated information to the terminal device 100.

Furthermore, the service provision unit 320 may check a predetermined level corresponding to the RSSI and transmission power values of the beacon signal of the beacon device located in the selected store, may check distance information corresponding to the predetermined level, may collect information related to the selected store based on the determined distance information, and then may generate the collected information as inducement information or detailed store information.

The storage unit 330 according to an embodiment of the present invention may store related information in order to provide a customized service based on a beacon signal. More specifically, the storage unit 330 may store a beacon signal (beacon identification information), the RSSI and transmission power values of the beacon signal, distance information, inducement information, detailed store information and collected information that are received from the terminal device 100. Furthermore, the storage unit 330 according to the second embodiment of the present invention may store a program or an application for distance calculation, information about a calculated distance, predetermined level information, etc. This storage unit 330 includes: magnetic media, such as a hard disk, a floppy disk and a magnetic tape; optical media, such as a Compact Disk Read-Only Memory (CD-ROM) and a Digital Video Disk (DVD); magneto-optical media, such as a floptical disk; Read Only Memory (ROM); Random Access Memory (RAM); and flash memory.

A method of providing a customized service based on a beacon signal in the system for providing a customized service configured as described above is described below with reference to the accompanying drawings. First, the method of providing a customized service based on a beacon signal in the terminal device according to the first embodiment of the present invention is described.

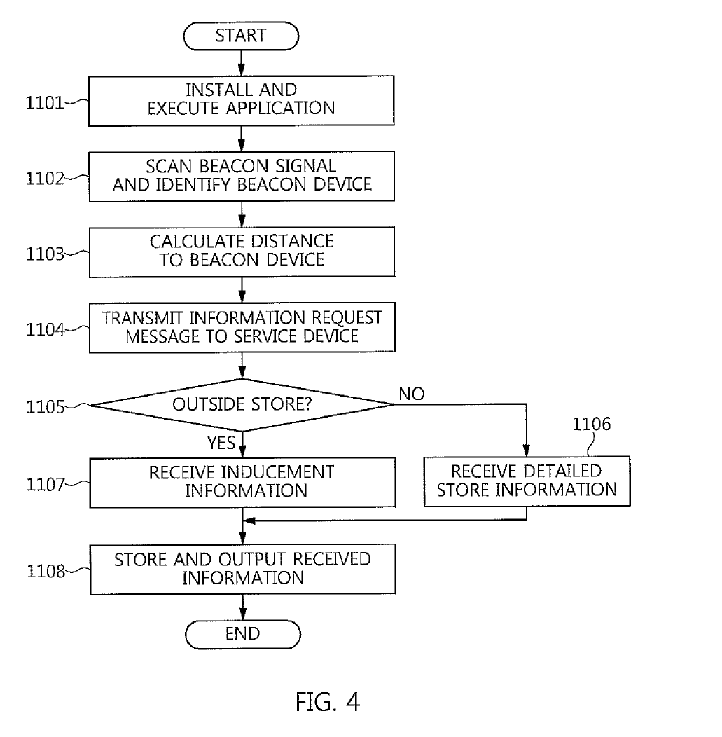

FIG. 4 is a flowchart illustrating the method of providing a customized service based on a beacon signal in the terminal device according to the first embodiment of the present invention.

Referring to FIG. 4, at step 1101, the terminal device 100 receives an application for a customized service based on a beacon signal from the service device 300, installs the application, executes the application in response to a request from a user, and then initiates the customized service.

Thereafter, at step 1102, the terminal device 100 scans beacon signals generated by one or more beacon devices 200 located in an adjacent area, and then identifies the beacon devices 200 using beacon identification information included in the scanned beacon signals.

Thereafter, at step 1103, the terminal device 100 calculates distances to the identified beacon devices 200. In this case, if the identified beacon devices 200 are plural in number, the terminal device 100 may display an execution screen for requesting a user to select a desired beacon device 200 and prompt the user to select the desired beacon device 200, or may automatically select a beacon device 200 and then calculate a distance based on conditions (a specific affiliated store, a store of interest, a frequently visited store, etc.) set by the user. In this case, the terminal device 100 may compare information about the calculated distance with a predetermined reference value and determine the location of the user. Furthermore, the terminal device 100 may include information about the determined location of the user in an information request message at step 1104.

Thereafter, at step 1104, the terminal device 100 transmits an information request message, including information about the calculated distance and the beacon identification information of the identified beacon device 200, to the service device 300. Accordingly, the service device 300 may identify a store, in which the beacon device 200 is located, using the received distance information and beacon identification information, may collect information related to the identified store, and then may determine whether a user has entered the store based on a generated distance. Accordingly, it may be possible to generate suitable inducement information or detailed information about the store based on a user depending on whether the user has entered the store.

Thereafter, at step 1105, the terminal device 100 may determine whether a user is located outside or inside the store using information about the calculated distance to the beacon device 200. If, as a result of the determination, it is determined that the user is located outside the store, the terminal device 100 receives inducement information from the service device 300 at step 1107.

In contrast, if the user enters the store or is located inside the store, the terminal device 100 receives detailed information about the store from the service device 300 at step 1106.

Thereafter, at step 1108, the terminal device 100 stores and outputs the received detailed store information or inducement information. Accordingly, if the user is located outside the store, the terminal device 100 may output the inducement information adapted to induce the user to enter the store, and the user may check the inducement information and then enter the store if interesting information is present. For example, if a time sale is performed in the identified store during lunch time (11:00 a.m. to 12:00 a.m.) in order to induce a customer to enter the store and then an event in which a 20% discount coupon is provided to a visiting user is held during the time sale, the payment device 400 may previously register information about the event with the service device 300, or may provide the information about the event to the service device 300 in response to a request. Accordingly, the terminal device 100 transmits the identification information of the beacon device 100 and information indicative that the user has not entered the store to the service device 300, and thus requests information. Thereafter, the terminal device 100 may receive event information, indicative that a time sale is performed during lunch time (11:00 a.m. to 12:00 a.m.) and then an event in which a 20% discount coupon is provided to a visiting user is held during the time sale from the service device 300, as inducement information. In this case, if the received information is provided to only a user who has subscribed to the alliance service of the store, the service device 300 checks user information and then determines whether the user has subscribed to the alliance service.

In contrast, if the user has entered the store or is located inside the store, the terminal device 100 may provide, for example, descriptions of today's product, a discount product, a product price and a preferred product to the user via detailed information about the store, or may provide an event, a coupon or the like in return for a visit to the store. For example, if the user has entered the store based on the received information about an event, the terminal device 100 transmits information indicative that the user has entered the store to the service device 300 and thus requests information. Accordingly, the terminal device 100 receives detailed information, such as information about the type and price of a specific product for a time sale, and a 20% discount coupon applicable to the product for the time sale from the service device 300. Furthermore, the service device 300 may search for information about a coupon or a gift certificate, issued in relation to the store, based on user information, and then may provide the found information to the terminal device 100. Accordingly, the terminal device 100 checks the provided information, and then downloads the coupon or the gift certificate issued in relation to the store.

Thereafter, if the terminal device 100 checks the detailed information about the store and then purchases a product, the terminal device 100 transmits the information about a coupon or a gift certificate, contained in the detailed information about the store, to the payment device 400, and then requests a discount on the product to be purchased.

A method of providing a customized service based on a beacon signal in the service device according to the first embodiment of the present invention is described in detail below.

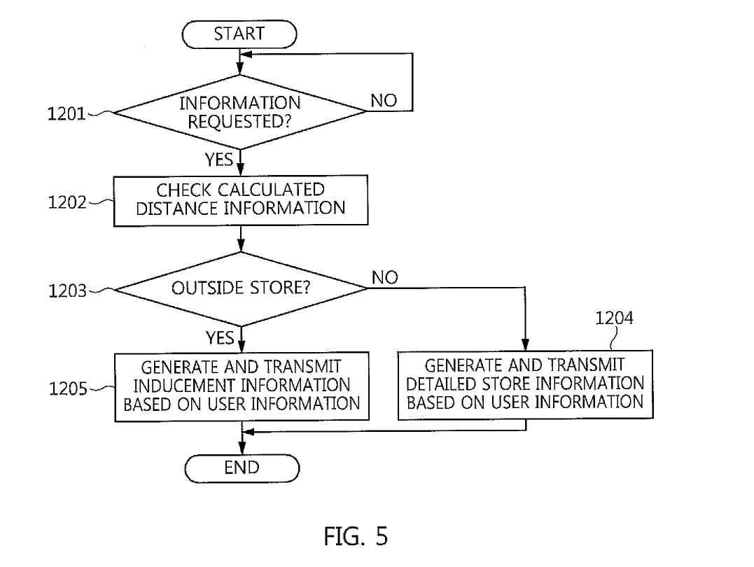

FIG. 5 is a flowchart illustrating the method of providing a customized service based on a beacon signal in the service device according to the first embodiment of the present invention.

Referring to FIG. 5, if the service device 300 receives an information request message, including information indicative of whether a user has entered a store, beacon identification information and information about a distance, from the terminal device 100 at step 1201, the service device 300 identifies a store, in which a beacon device 200 is located, using the beacon identification information included in the information request message and then collects information related to the identified store at step 1202. In this case, the service device 300 determines a distance to the beacon device 200, that is, the location of a user, using the information about the distance or the information about whether the user has entered the store.

Accordingly, at step 1203, the service device 300 determines whether the determined location of the user is present outside the identified store, that is, whether the user has entered the store. If, as a result of the determination, it is determined that the user has entered the store, the service device 300 sorts out information to be applied to detailed information about the store from the collected information, generates the sorted-out detailed information about the store as the customized information, and then transmits the generated customized information to the terminal device 100 at step 1204. In this case, the service device 300 may check information managed in relation to a user, that is, user information, and then may extract user-preferred information from the detailed information about the store, which includes a preferred product preset by the user or has been sorted out using previous payment information. Accordingly, the service device 300 may generate the extracted preferred information as the detailed information about the store. For example, if the terminal device 100 has entered the store, the service device 300 automatically transmits detailed information, such as the specific type and price of the product for the time sale based on the inducement information, and a 20% discount coupon applicable to the product for the time sale product to the terminal device 100. Furthermore, the service device 300 may search for information about a coupon or a gift certificate, issued in relation to the store, based on user information, and then may provide the found information to the terminal device 100.

Furthermore, the service device 300 may search for whether an alliance service to which the user has subscribed is present in the store identified based on user information, may search for information about one or more of the type, price and discount of a product related to the found information about an alliance service, and then may generate the found information as detailed information about the store of the user.

In contrast, if, as a result of the determination, it is determined that the user is located outside the store, the service device 300 sorts out information to be applied to inducement information from the collected information, generates the sorted-out inducement information as customized information and then transmits the generated customized information to the terminal device 100 at step 1205. In this case, the service device 300 may check information managed in relation to the user, that is, user information, and then may select a preferred store using a preferred store and information of interest preset by the user and information about a store included in previous payment information. Accordingly, the service device 300 may extract inducement information related to the selected preferred store from the sorted-out inducement information, and then may generate the extracted inducement information as customized information. For example, the service device 300 may generate event information (a time sale is performed during lunch time (11:00 a.m. to 12:00 a.m. and an event in which a 20% discount coupon is provided to a visiting user is held during the time sale), registered in connection with the identified store, as the inducement information. Furthermore, the service device 300 may search for information about whether an alliance service to which the user has subscribed is present in a store identified based on user information, may check whether discount information or event information related to the found information about an alliance service is present, and then may generate the found information as inducement information only for the user. For example, if a 10% discount on today's product may be offered via an alliance service card to which the user has subscribed, this information may be generated as the inducement information. If a product, which has been registered as the information of interest by the user, is present, information indicative of a store, in which a product of interest is sold, may be generated as the inducement information when the corresponding product is sold in an identified store.

Meanwhile, in connection with the second embodiment of the present invention, a method of providing a customized service based on a beacon signal, in which the service device 300 calculates distances to the beacon devices 200 using beacon signals scanned by the terminal device 100 and then transmits collected information depending on whether a user has entered a store, which is determined using information about the calculated distances, to the terminal device 100, is described with reference to the accompanying drawings. First, the method of providing a customized service based on a beacon signal in the terminal device according to the second embodiment of the present invention is described below.

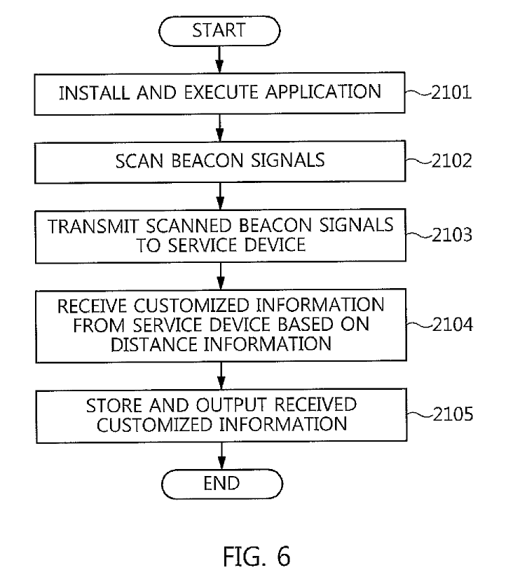

FIG. 6 is a flowchart illustrating the method of providing a customized service based on a beacon signal in the terminal device according to the second embodiment of the present invention.

Referring to FIG. 6, at step 2101, the terminal device 100 receives an application for a customized service based on a beacon signal from the service device 300, installs the application, executes the application in response to a request from a user, and thus initiates the customized service.

Thereafter, at step 2102, the terminal device 100 scans beacon signals generated by one or more beacon devices 200 located in an adjacent area, and then identifies the beacon devices 200 using beacon identification information included in the scanned beacon signals

Accordingly, at step 2103, the terminal device 100 transmits the scanned beacon signals to the service device 300.

Thereafter, the terminal device 100 receives customized information based on information about calculated distances to the service device 300 at step 2104, and stores the received customized information and then outputs the received customized information to an execution screen at step 2105.

A method of providing a customized service based on a beacon signal in the service device according to the second embodiment of the present invention is described in detail below.

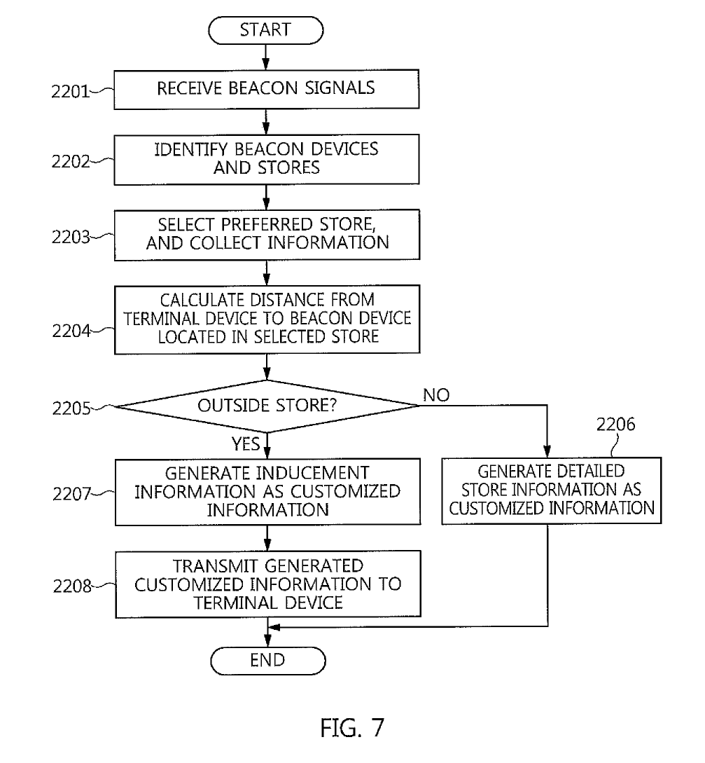

FIG. 7 is a flowchart illustrating the method of providing a customized service based on a beacon signal in the service device according to the second embodiment of the present invention.

Referring to FIG. 7, the service device 300 receives scanned beacon signals from the terminal device 100 at step 2201, and identifies corresponding stores where the beacon devices 200 corresponding to identification information included in the received beacon signals are located at step 2202.

Thereafter, at step 2203, the service device 300 selects a user-preferred store from among the identified stores based on preset user information, and then collects information related to the selected store.

Thereafter, at step 2204, the service device 300 calculates a distance from the terminal device 100 to the beacon device 200 of the selected store using the beacon signal of the beacon device 200 located in the selected store.

Thereafter, at step 2205, the service device 300 determines the location of a user, that is, whether the user has entered the selected store, using distance information (information about the distance to the beacon device 200).

If, as a result of the determination, it is determined that the user has entered the store, the service device 300 sorts out information to be applied to detailed information about the store from the collected information and then generates the sorted-out detailed information about the store at step 2206. In this case, the service device 300 may check information managed in relation to the user, that is, user information, and then may extract user-preferred information from the detailed information about the store, which includes a preferred product preset by the user or has been sorted out using previous payment information. Accordingly, the service device 300 may generate the extracted preferred information as the detailed information about the store.

In contrast, if, as a result of the determination, it is preferred that the user is located outside the store, the service device 300 sorts out information to be applied to inducement information from the collected information and generates the sorted-out inducement information at step 2207. In this case, the service device 300 may check information managed in relation to the user, that is, user information, and then may select a preferred store using a preferred store and information of interest preset by the user and information about the store included in previous payment information. Accordingly, the service device 300 may extract inducement information related to the selected preferred store from the sorted-out inducement information, and then may generate the extracted inducement information.

Accordingly, at step 2208, the service device 300 transmits the inducement information or detailed information about the store, generated depending on whether the user has entered the store, to the terminal device 100.

In accordance with the methods of providing a customized service based on a beacon signal according to the embodiments of the present invention, the service device 300 may determine whether a user has actually entered a store by taking into account information about a distance, received from terminal device 100 or directly calculated, and the value of a distance from the beacon device 200 to an entrance to the store. Accordingly, the service device 300 may check the number of entering people during a specific time span (for example, each time span, each day, each week, each month, or the like), and then may manage the number of entering people through the mapping of the number of entering people to user information. In this case, the service device 300 may provide a service related to the management of the store to the store payment device 300 using information about the number of entering people during the specific time span. Furthermore, the service device 300 may determine the popularity, preferred age, preferred gender and busy or idle time span of the store using the information about the number of entering people during the specific time span. Accordingly, the service device 300 may store and manage the determined information as information about the management of the store for a customized service. Furthermore, the service device 300 may determine the age and gender of the user, a time span in which the user has frequently visited the store, etc. based on user information, may search for a suitable product or service, provided by the store, by taking into account the determined user information, and then may generate the found information as inducement information or detailed information about the store. Furthermore, the service device 300 may identify the store, chiefly visited by the user during a current time span, based on the scanned beacon signals by taking into account the life pattern of the user, may select the identified store as a preferred store, may collect information related to the selected store, and then may provide the collected information as inducement information or detailed information about the store for the provision of a customized service to the user. In the same manner, the terminal device 100 may receive the managed user information and payment information from the service device 300, may select a preferred store based on scanned beacon signals, and may request information about only the selected store from the service device 300.

Accordingly, the service device 300 does not provide information for all scanned beacon signals, but provides suitable information only for a selected store, thereby preventing the indiscriminate provision of information.

In accordance with the embodiments of the present invention, the terminal device 100 determines whether a user has entered a store through the determination of a distance to the beacon device 200 based on a beacon signal, that is, the strength of the beacon signal, and then receives different information related to the store depending on whether the user has entered the store. Accordingly, if the strength of the beacon signal is low, it is determined that the user does not have entered the store, and then the user may be induced to enter the store via various types of information provided by the store. In contrast, if the strength of the beacon signal is high, it is determined that a user has entered the store, and then the user may receive information that allows the user to easily purchase a product in the store. Accordingly, the user can receive a customized service that provides suitable information depending on whether the user has entered the store.

Meanwhile, program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, for example, magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine code, such as code created by a compiler, and high-level language code executable by a computer using an interpreter. The hardware devices may be configured to operate as one or more software modules in order to perform the operation of the present invention, and the vice versa.

Furthermore, a computer program (also known as a program, software, a software application, a script, or code) that is installed on an apparatus according to the present disclosure and is used to perform a method according to the present disclosure may be written in any form of programming language, including a compiled or interpreted language or an a priori or procedural language, and may be deployed in any form, including a stand-alone program, a module, a component, a subroutine, or any other unit suitable for use in a computing environment. The computer program does not necessarily correspond to a file in a file system. The program may be stored in a single file provided to a requested program, in multiple interactive files (for example, files each storing one or more modules, a subordinate program or part of code), or part of a file holding another program or data (for example, one or more scripts stored in a markup language document). The computer program may be deployed to be located and executed on one computer at a single site or to be distributed across multiple sites and executed on multiple computers interconnected over a communication network.

While the present specification contains many details of particular implementations, these should not be construed as limitations on the scope of the invention or what may be claimed, but, rather, should be construed as descriptions of features specific to particular embodiments of the invention. The particular features that are described in the present specification in the context of separate embodiments may be also implemented in combination in a single embodiment. Conversely, the various features that are described in the context of a single embodiment may be also implemented in multiple separate embodiments or in any suitable sub-combinations. Moreover, although features may be described as operating in a certain combination and the certain combination may be claimed as such, one or more features of the claimed combination may be excluded from the combination in some cases, and the claimed combination may be changed to sub-combinations or variations of sub-combinations.

In the same manner, while operations have been described in a particular order in the drawings, this should not be construed as requiring that the operations should be performed in the described particular order or in a sequential order or all the described operations should be performed in order to achieve desirable results. In some cases, multitasking and parallel processing may be advantageous. Furthermore, the separation of various system components in the embodiments described above should not be construed as requiring such separation in all embodiments, and it should be understood that the described program components and systems may be generally integrated together in single software products or packaged into multi-software products.

The present disclosure relates to a method, apparatus and system for providing a customized service based on a beacon signal, which are capable of inducing a user to enter a store or providing information for a customized service, such as detailed information about the store, depending on a distance from the beacon device to a terminal device, which is obtained using a beacon signal generated by a beacon device installed in the store. Accordingly, information related to the store is provided to only a user who is located adjacent to the store and can receive the beacon signal, and thus the user can receive only required customized information without indiscriminately receiving unnecessary information.

Furthermore, since the present invention has sufficient commercial potential or sales potential and can be practically and explicitly implemented, the present disclosure has industrial availability.

Although the specific embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. A terminal device, comprising:
a communication unit configured to receive a beacon signal transmitted from at least one beacon device via short-range wireless communication, and to communicate with a service device over a communication network to provide a customized service based on the beacon signal;
a control unit functionally connected with the communication unit, and configured to scan the beacon signal transmitted from the beacon device, to determine whether a user has entered a store, in which the beacon device is located, through calculation of a distance to the beacon device using the scanned beacon signal, to transmit information, indicative of whether the user has entered the store, to the service device, and to receive information related to the store, adapted to differ depending on whether the user has entered the store, from the service device; and
an output unit functionally connected with the control unit, and configured to output the information related to the store, received from the service device, depending on whether the user has entered the store in order to provide the customized service to the user.

2. The terminal of claim 1, further comprising a storage unit configured to store the information related to the store and an application;
wherein the information related to the store is provided by the service device depending on whether the user has entered the store under a control of the control unit, and the application is used to execute the customized service based on the beacon signal.

3. The terminal of claim 1, wherein the control unit is further configured to calculate the distance to the beacon device using Received Signal Strength Indicator (RSSI) and transmission power values of the scanned beacon signal.

4. The terminal of claim 1, wherein the control unit is further configured to, if information about the calculated distance is equal to or larger than a predetermined reference value, determine that the user is located outside the store and then receive inducement information, adapted to induce the user to enter the store, from the service device as the information related to the store.

5. The terminal of claim 4, wherein the inducement information comprises one or more of location information, discount information, event information and advertising information of the store.

6. The terminal of claim 1, wherein the control unit is further configured to, if information about the calculated distance is smaller than a predetermined reference value, determine that the user has entered the store and then receive detailed information about the store from the service device as the information related to the store.

7. The terminal of claim 6, wherein the detailed information about the store is information to be received if the user has entered the store, and comprises one or more of product-on-sale information, product price information, discount product information, best-selling product information, product-of-interest information, a coupon, a gift certificate, detailed event information and alliance service information.

8. A service device, comprising:
a communication unit configured to operate in conjunction with at least one terminal device over communication network, and to perform communication for a customized service; and
a service provision unit functionally connected with the communication unit, and configured to, when a request for information is received from the terminal device, determine whether a user has entered a store, in which a beacon device is located, using information about a distance to the beacon device and identification information of the beacon device received from the terminal device, to generate different information related to the store to be provided to the user depending on whether the user has entered the store, and to provide the generated information related to the store to the terminal device.

9. The terminal of claim 8, wherein the service provision unit is further configured to identify the store, in which the beacon device is located, using identification information of the beacon device, to collect information related to the identified store, and to generate inducement information adapted to induce the user to enter the identified store from the collected information based on user information if the user is located outside the identified store.

10. The terminal of claim 8, wherein the service provision unit is further configured to identify the store, in which the beacon device is located, using identification information of the beacon device, to collect information related to the identified store, and to generate detailed information about the identified store from the collected information if the user has entered the identified store based on user information.

11. A computer-readable storage medium having stored therein computer-readable program instructions that, when executed by a computer, cause the computer to:
scan a beacon signal transmitted from at least one beacon device via short-range wireless communication;
identify the beacon device using the scanned beacon signal;
calculate a distance to the identified beacon device using the beacon signal of the identified beacon device;
determine whether a user has entered a store, in which the beacon device is located, using information about the calculated distance;
transmit information indicative of whether the user has entered the store to a service device;
receive information related to the store, adapted to differ depending on whether the user has entered the store, from the service device; and
store and output the information related to the store.
